(19) United States
(12) Patent Application Publication
(10) Pub. No.: US 2009/0049163 A1
(43) Pub. Date: Feb. 19, 2009

(54) DYNAMICALLY TYPED EXTENSIBLE MIB FOR SNMP AGENTS

(76) Inventor: Matthew Douglas Love, Perth (AU)

Correspondence Address: IBM CORP (YA);C/O YEE & ASSOCIATES PC, P.O. BOX 802333, DALLAS, TX, 75380, US

(21) Appl. No.: 11/840,653

(22) Filed: Aug. 17, 2007

(51) Int. Cl. G06F 15/173

(52) U.S. Cl. 709/223

(57) ABSTRACT

The exemplary embodiments provide a computer implemented method, apparatus, and computer usable program code for storing data associated with a Simple Network Management Protocol managed information base. A storage area identifier that defines a storage area is reserved. The storage area does not have an associated pre-defined set of identifiers that a user can perform Simple Network Management Protocol operations on. An input is received from a requester, wherein the input comprises an input identifier. A determination is made as to whether storage area identifier is a prefix of the input identifier. Responsive to a determination that storage area identifier is a prefix of the input identifier, the input is processed without referring to a definition file for the managed information base. A response indicating a result is sent to the requester.

### BACKGROUND OF THE INVENTION

1. Field of the Invention

The present invention relates generally to data processing systems. More specifically, exemplary embodiments provide a method, computer program product and a system for storing data associated with a simple network management protocol managed information base.

2. Description of the Related Art

SNMP stands for “Simple Network Management Protocol,” which is a protocol governing network management and the monitoring of network devices and their functions. SNMP is generally used with internet protocol (IP) networks. Simple Network Management Protocol is a protocol used by network hosts to exchange information used in the management of networks. Simple Network Management Protocol network management is based on the client and server model. Each managed host runs a process called an agent, known as an SNMP Agent. The SNMP agent is a server process that maintains the management information base (MIB) database for the host.

A management information base comprises a collection of objects in an actual or virtual database used to manage entities, such as, for example, but not limited to, routers, switches, and so forth, in a network. Objects in the MIB are defined using Abstract Syntax Notation One (ASN.1). The software that performs the parsing is an MIB compiler. The database is hierarchical, or tree structured, in nature, and entries are addressed through object identifiers (OIDs).

An SNMP agent is coded in source code and uses an MIB text file describing an interface to the SNMP agent. When creating an SNMP agent, the developer is typically required to define the structure and types of the information supplied by the agent in a textual MIB file, and then implement the under-lying agent source code in a programming language to populate the MIB.

Changes to the structure or type of information supplied, such as, for example, but not limited to, how the information is indexed, the data types used, the location of data in the MIB, and adding or removing data objects, involves substantial effort for the developer in both changing the MIB file and the source code. In a commercial environment, where the end user may not have access to the agent source code required to make such changes, the end user may find it almost impossible to alter or customize the SNMP agent to the needs of the end user, no matter how small a change, without the assistance of the developers of the SNMP agent.

As well as the difficulty in altering or extending existing MIBs, agent developers are normally reluctant to spend time and resources creating custom MIBs if the return on investment is not sufficient, preferring a ‘one-size-fits-all’ approach. For example, a customer may require performance statistics for an in-house application to be accessible via SNMP.

### SUMMARY OF THE INVENTION

The exemplary embodiments provide a computer implemented method, apparatus, and computer usable program code for storing data associated with a Simple Network Management Protocol managed information base. A storage area identifier that defines a storage area is reserved. The storage area does not have an associated pre-defined set of identifiers that a user can perform Simple Network Management Protocol operations on. An input is received from a requester, wherein the input comprises an input identifier. A determination is made as to whether the storage area identifier is a prefix of the input identifier. Responsive to a determination that the storage area identifier is a prefix of the input identifier, the input is processed without referring to a definition file for the managed information base. A response indicating a result is sent to the requester.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 is a block diagram of a data processing system in which the illustrative embodiments may be implemented;

FIG. 3 is a block diagram of a system for storing data associated with an SNMP managed information base in accordance with an exemplary embodiment; and

FIG. 4 is a flowchart illustrating the operation of storing data associated with an SNMP managed information base in accordance with an exemplary embodiment.

### DETAILED DESCRIPTION OF THE PREFERRED EMBODIMENT

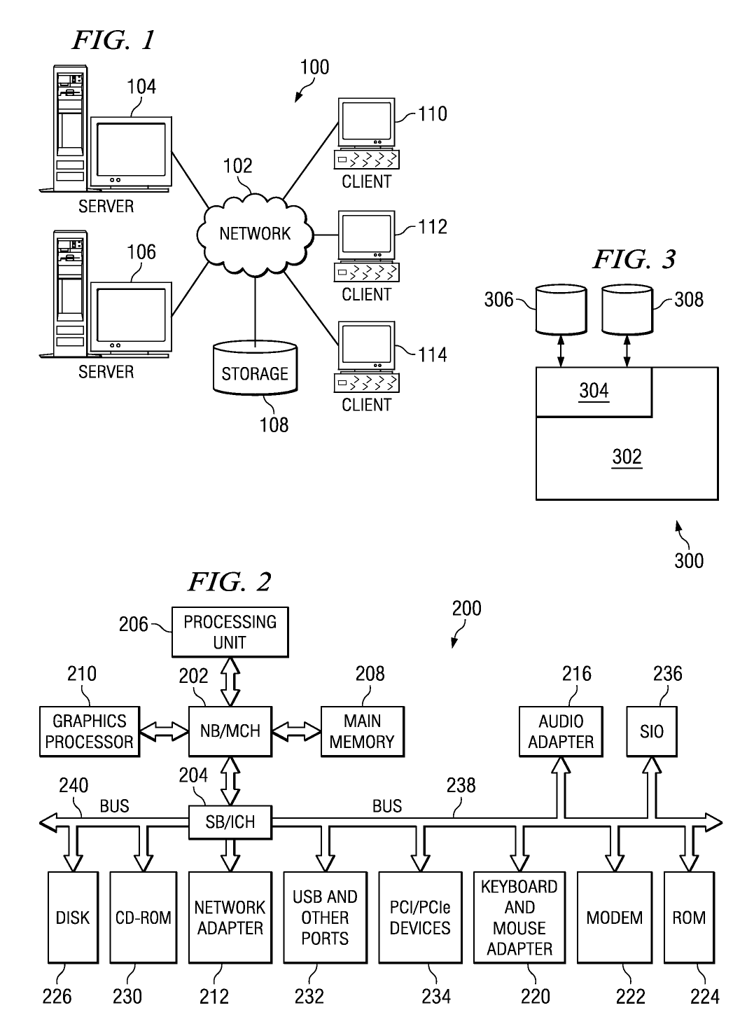

With reference now to the figures and in particular with reference to FIGS. 1-2, exemplary diagrams of data processing environments are provided in which illustrative embodiments may be implemented. It should be appreciated that FIGS. 1-2 are only exemplary, and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including a north bridge and memory controller hub (NB/MCH) 202 and a south bridge and input/output (I/O) controller hub (SB/ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the NB/MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238, and hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system, and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course, the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

Exemplary embodiments allow an end user with no access to an SNMP agent source code to populate custom MIBs with data. In an exemplary embodiment, a user populates custom MIBs with data via standard SNMP Set operations. An SNMP SET operation is used by a management application to modify or populate the value of the managed object. The structure, or type of information, provided may also be changed, within Simple Network Management Protocol standards, with no impact to the providing SNMP agent. The data can then be retrieved by subsequent SNMP GET or GETNEXT requests.

Exemplary embodiments provide for reserving three identifiers in the MIB of the SNMP agent. The first identifier, hereinafter referred to as a base object identifier, Base OID, or storage area OID, defines a storage area that is a MIB that is separate from the regular MIB; hereinafter referred to as a scratch pad area, a scratch pad storage area, and sometimes as a scratch pad MIB. The storage area OID serves as a prefix for both the second and third identifiers.

The second identifier is a functional identifier that identifies operations that are allowed access to the scratch pad storage area. This first functional identifier is a read/write operation identifier, hereinafter referred to as the scratch pad OID. This scratch pad OID is, in turn, used as a prefix by any Simple Network Management Protocol operations that read or write to the scratch pad area, such as the Simple Network Management Protocol operations, SET, GET, and GETNEXT. The first functional identifier has the storage area OID as a prefix for the first functional OID.

The third identifier is a second functional identifier that identifies operations that are allowed access to the scratch pad storage area. This second functional identifier is an erase operation identifier, hereinafter referred to as the erase object OID. The second functional identifier identifies an operation that removes an object and the OID of the object from the defined storage area. A user will perform a SET operation with an erase object as an input OID. As a result of this operation, one or more objects, and the OIDs for the objects will be removed from the defined storage area. The second functional identifier is distinct from the first functional identifier and has the storage area identifier as a prefix for the second functional OID.

Input to and output from the scratch pad storage area is supported by the SNMP agent source code, and can be of any data type that conforms to the Simple Network Management Protocol standard. However, the data in the scratch pad does not have to be a data type that is defined in the MIB file of the SNMP agent. Furthermore, the scratch pad storage area does not enforce any limits on the OID of the input. Typically, MIBs have a pre-defined set of OIDS that the user can perform SNMP operation on. This is not the case for the scratch pad storage area. Any OID that has the storage area OID as a prefix can be used in the scratch pad storage area.

Normally, when data is written to an MIB, a type check is performed to make sure the data conforms to the type defined by the MIB file. However, when data is written to the scratch pad area, the data type check is omitted.

A scratch pad OID identifies the scratch pad. Subsequent SNMP GET or GETNEXT requests for any OID that has the scratch pad OID as a prefix results in the SNMP agent looking up the requested OID in a data structure, such as, for example, but not limited to, a radix tree, a binary tree, and so forth, and returning the appropriate stored value and data type to the user.

During a GET operation, the user specifies the OID to be retrieved from the scratch pad. The SNMP agent looks in the data structure to find the value associated with that OID. If an OID exists, the value is returned as a varbind. If no such OID exists in the data structure, an exception value is returned to indicate failure of the operation.

During a GETNEXT operation, the user specifies an OID and the agent looks in the data structure to find a value associated with the OID that is the immediate successor to the user specified OID under lexicographical ordering. If there are no more objects lexicographically next to the user specified OID, an exception value is returned.

For example, assume a scratch pad containing the three elements: .1.2.3=A, .1.2.4=B, and .1.2.5=C. Performing GETNEXT(.1.2.3) will return the varbind (1.2.4, B). Performing GETNEXT(.1.2.4) will return the varbind (1.2.5, C). Performing GETNEXT(.1.2.5) will return an exception, called endOfMibView, to indicate there are no more values after .1.2.5.

Thus, OIDs that have the scratch pad OID as a prefix provide an artificial but well-defined structure for data. The structure is said to be artificial in that the structure is not tied to the SNMP agent source code. A user inputs data to be stored in the scratch pad by using an SNMP SET operation. An SNMP SET operation requires a varbind as the input. A varbind contains an OID, a data type, and a value. The data to be stored is the value.

In an exemplary embodiment, the scratch pad OID is .1.3.6.1.4.1.1977.50.1. Any SNMP Set operations to an OID with this scratch pad OID as a prefix, such as, for example .1.3.6.1.4.1.1977.50.1.2, or .1.3.6.1.4.1.1977.50.1.2.3.4.5.6, will result in the associated varbind being stored internally by the SNMP agent in a data structure that associates the value and data type of the varbind with the specified OID. Subsequent SNMP GET or GETNEXT requests to any OID with a prefix that matches the scratch pad OID results in the SNMP agent looking up the requests in the data structure and returning the appropriate stored value and data type or error message.

Take for example the case where a customer wants to monitor a particular statistic that is not implemented in the current SNMP agent, for example, network file system (NFS) retransmission rate as reported by a nfsstat tool. Network File System (NFS) is a network file system protocol that allows a user on a client data processing system to access files over a network as easily as if the network devices were attached to the user's local disks. The nfsstat tool is used to gather various statistics about the network file system.

Standard development practice would require a developer to create both a new MIB object and the code to retrieve that statistic from the operating system or application. Instead, exemplary embodiments allow the customer to use a simple shell script to parse the output of the nfsstat tool, and, using the SNMP agent, insert the statistics into the scratch pad, making the statistics available to other parties, via the SNMP agent. A shell script is a script written for the shell, or command interpreter, of an operating system. Typical operations performed by shell scripts include file manipulation, program execution, and printing text. A shell script contains operating system commands that are processed in a batch method, one at a time, until complete.

Exemplary embodiments provide for removing data from the scratch pad area by assigning another OID in the MIB of an SNMP agent as the “erase” object. In an exemplary embodiment, the erase OID is .1.3.6.1.4.1.1977.50.2. By setting the value of the erase object to the OID of a previously stored object, the previously stored object is removed from the internal data structure. Entire branches of the MIB tree beneath the scratch pad OID can be erased by specifying a partial OID.

For example, consider an MIB containing six values with the following OIDs, all relative to the assigned scratch pad OID:

scratch pad.1.2.1

scratch pad.1.2.2

scratch pad.1.2.3.1

scratch pad.1.2.3.2

scratch pad.2.1

scratch pad.2.2

Setting the value of the erase object to the OID scratch pad.1.2 will erase the first four values, whilst setting the value of the erase object to scratch pad.2 will remove the last two values. Setting the erase object to the base OID will result in all values in the MIB being erased. Only OIDs with a prefix matching the scratch pad OID may be set as the erase object value. Attempting to set the value of the erase object to an OID that dos not contain the scratch pad OID as a prefix will return a badvalue error. Also, note that the erase object can only be set to a value that is an object identifier type. Attempting to set it to a different data type such as a string or an integer will result in the agent returning an exception value to indicate an incorrect type.

FIG. 3 is a block diagram of a system for storing data associated with an SNMP managed information base in accordance with an exemplary embodiment. System 300 illustrates a system for implementing a method of storing data associated with an SNMP managed information base. System 300 comprises server 302, which may be implemented as a data processing system such as data processing system 200 in FIG. 2, MIB database 306 and scratch pad database 308. Server 302 has SNMP agent 304 resident. SNMP agent 304 writes to MIB database 306 for requests that reference OIDs that do not have a prefix matching the OID of scratch pad database 308. SNMP agent 304 writes to scratch pad database 308 for requests that reference OIDs that do have a prefix matching the OID of scratch pad database 308.

While the present exemplary embodiment presents the scratch pad database as a separate database, apart from the MIB database, in an alternate embodiment the scratch pad database is implemented as part of the MIB database. Also, depending upon the particular implementation, the scratch pad database and the MIB database may be implemented as resident on server 302 or separate from server 302.

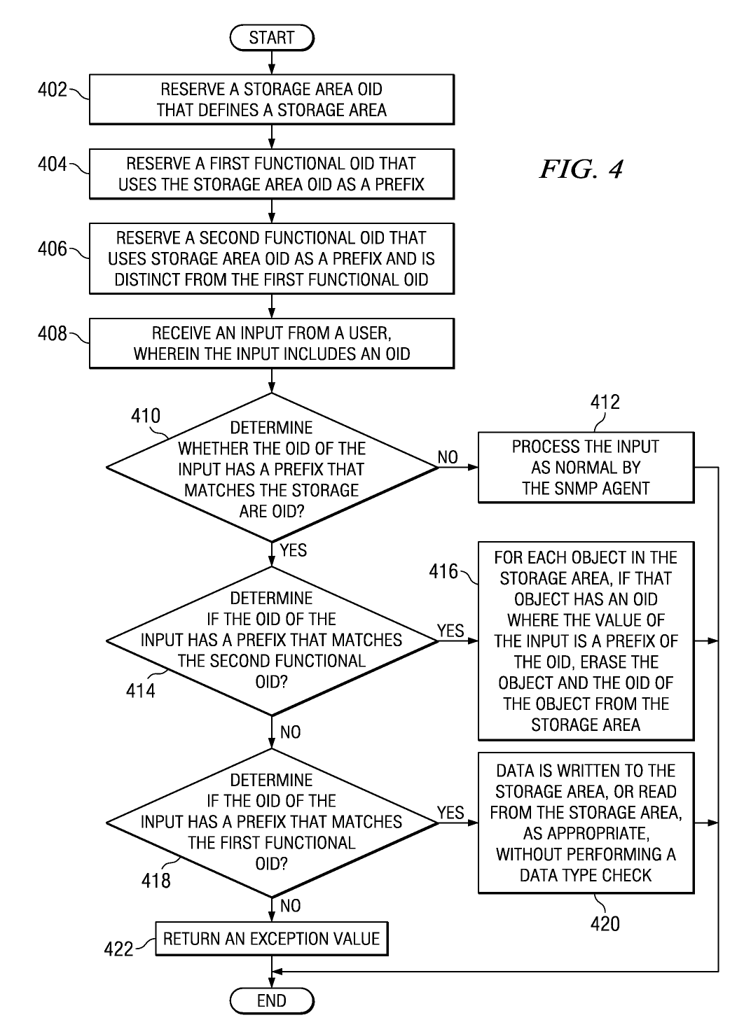

FIG. 4 is a flowchart illustrating an operation of storing data associated with an SNMP managed information base in accordance with an exemplary embodiment. The steps of FIG. 4 may be performed by an SNMP agent, such as SNMP agent 304 in FIG. 3, implemented on a server, such as data processing system 200 in FIG. 2. The operation begins by reserving a storage area OID that defines a storage area (step 402). The defined storage area does not enforce any limitations on input OIDs. Next, a first functional OID that uses the storage area OID as a prefix is reserved (step 404). A second functional OID that uses the storage area OID as a prefix and is distinct from the first functional OID is reserved (step 406). The SNMP agent receives an input from a user, wherein the input includes an OID (step 408). The SNMP agent determines whether the OID of the input has a prefix that matches the storage area OID (step 410).

If the SNMP agent determines that the OID of the input does not have a prefix that matches the storage area OID (a no output to step 410), the input is processed as normal by the SNMP agent (step 412) and the operation ends. If the SNMP agent determines that the OID of the input does have a prefix that matches the storage area OID (a yes output to step 410), the SNMP agent determines whether the OID of the input has a prefix that matches the second functional OID (step 414).

If the SNMP agent determines that the OID of the input has a prefix that matches the second functional OID (a yes output to step 414), then, for each object in the storage area, if that object has an OID where the value of the input is a prefix of the OID, erase the object and the OID of the object from the storage area (step 416) and the process ends. If the SNMP agent determines that the OID of the input does not have a prefix that matches the second functional OID (a no output to step 414), the SNMP agent determines whether the OID of the input has a prefix that matches the first functional OID (step 418).

If the SNMP agent determines that the OID of the input does have a prefix that matches the first functional OID, (a yes output to step 418), data is written to the storage area or read from the storage area, as appropriate, without performing a data type check (step 420) and the operation ends. If the SNMP agent determines that the OID of the input does not have a prefix that matches the first functional OID, (a no output to step 418), an exception value, such as noSuchObject, or BadValue is returned to the user (step 422) and the operation ends.

Exemplary embodiments allow an end user with no access to the SNMP agent source code to populate custom MIBs with data. In an exemplary embodiment, a user populates custom MIBs with data via standard SNMP SET operations. The structure or type of information provided may also be changed, within SNMP standards, with no impact on the providing SNMP agent. The data can then be retrieved by subsequent SNMP GET or GETNEXT requests.

Exemplary embodiments provide for assigning an OID in the MIB of the SNMP agent as the object identifier for the ‘scratch pad’ area. A scratch pad is a storage area, defined by the MIB file, into which a user can write additional data using SNMP operations. Input to and output from a scratch pad is supported by the SNMP agent source code, and can be of any data type that conforms to the Simple Network Management Protocol standard. However, the data in the scratch pad does not have to be a data type that is defined in the MIB file of the SNMP agent.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for storing data associated with a Simple Network Management Protocol managed information base, the method comprising:
reserving a storage area identifier to define a storage area, wherein the storage area does not have an associated pre-defined set of identifiers that a user can perform Simple Network Management Protocol operations on;
receiving an input from a requester, wherein the input comprises an input identifier;
determining if the storage area identifier is a prefix of the input identifier;
in response to a determination that the storage area identifier is a prefix of the input identifier, processing the input without referring to a definition file for the managed information base; and
sending a response indicating a result to the requester.

2. The computer implemented method of claim 1, further comprising:
wherein the input further comprises a value;
reserving a first functional identifier, wherein the storage area identifier is a prefix of the first functional identifier and wherein the first functional identifier identifies operations that are allowed access to the storage area in order to perform a read or write operation; and
reserving a second functional identifier, wherein the storage area identifier is a prefix of the second functional identifier and wherein the second functional identifier is distinct from the first operational identifier and wherein the second functional identifier identifies operations that are allowed access to the storage area in order to remove objects from the storage area.

3. The computer implemented method of claim 2, further comprising:
determining if the second functional identifier matches the input identifier;
responsive to a determination that the second functional identifier matches the input identifier, determining, for each item of data in the storage area, whether the item of data has an item identifier wherein the value of the input is a prefix of the item identifier; and
responsive to a determination that the item of data has an item identifier wherein the value of the input is a prefix of the item identifier, erasing the item of data from the storage area and erasing the item identifier of the item of data.

4. The computer implemented method of claim 2, further comprising:
responsive to a determination that the first functional identifier is not a prefix of the input identifier and that the second functional identifier does not match the input identifier, returning an error message to the requester.

5. The computer implemented method of claim 2, further comprising:
determining if the first functional identifier is a prefix of the input identifier; and
responsive to a determination that the first functional identifier is a prefix of the input identifier, performing a read or write operation in the storage area for the value.

6. A computer program product comprising:
a computer usable medium having computer usable program code for storing data associated with a Simple Network Management Protocol managed information base, the computer program product comprising:
computer usable program code for reserving a storage area identifier to define a storage area, wherein the storage area does not have an associated pre-defined set of identifiers that a user can perform Simple Network Management Protocol operations on;
computer usable program code for receiving an input from a requestor, wherein the input comprises an input identifier;
computer usable program code for determining if the storage area identifier is a prefix of the input identifier;
computer usable program code for, in response to a determination that the storage area identifier is a prefix of the input identifier, processing the input without referring to a definition file for the managed information base; and
computer usable program code for sending a response indicating a result to the requester.

7. The computer program product of claim 6, further comprising:
wherein the input further comprises a value;
computer usable program code for reserving a first functional identifier, wherein the storage area identifier is a prefix of the first functional identifier and wherein the first functional identifier identifies operations that are allowed access to the storage area in order to perform a read or write operation; and
computer usable program code for reserving a second functional identifier, wherein the storage area identifier is a prefix of the second functional identifier and wherein the second functional identifier is distinct from the first operational identifier and wherein the second functional identifier identifies operations that are allowed access to the storage area in order to remove objects from the storage area.

8. The computer program product of claim 7, further comprising:
computer usable program code for determining if the second functional identifier matches the input identifier;
computer usable program code for, responsive to a determination that the second functional identifier matches the input identifier, determining, for each item of data in the storage area, whether the item of data has an item identifier wherein the value of the input is a prefix of the item identifier; and
computer usable program code for, responsive to a determination that the item of data has an item identifier wherein the value of the input is a prefix of the item identifier, erasing the item of data from the storage area and erasing the item identifier of the item of data.

9. The computer program product of claim 7, further comprising:
computer usable program code for, responsive to a determination that the first functional identifier is not a prefix of the input identifier and that the second functional identifier does not match the input identifier, returning an error message to the requester.

10. The computer program product of claim 7, further comprising:
computer usable program code for determining if the first functional identifier is a prefix of the input identifier; and
computer usable program code for, responsive to a determination that the first functional identifier is a prefix of the input identifier, performing a read or write operation in the storage area for the value.

11. A data processing system for storing data associated with a Simple Network Management Protocol managed information base, the data processing system comprising:
a bus;
a communications unit connected to the bus;
a storage device connected to the bus, wherein the storage device includes computer usable program code; and
a processor unit connected to the bus, wherein the processor unit executes the computer usable program code to reserve a storage area identifier to define a storage area, wherein the storage area does not have an associated pre-defined set of identifiers that a user can perform Simple Network Management Protocol operations on; receive an input from a requester, wherein the input comprises an input identifier; determine if the storage area identifier is a prefix of the input identifier; in response to a determination that the storage area identifier is a prefix of the input identifier, process the input without referring to a definition file for the managed information base; and send a response indicating a result to the requester.

12. The data processing system of claim 11, wherein the input further comprises a value; and
wherein the processor unit executes the computer usable program code further comprising computer usable program code to reserve a first functional identifier, wherein the storage area identifier is a prefix of the first functional identifier and wherein the first functional identifier identifies operations that are allowed access to the storage area in order to perform a read or write operation; and reserve a second functional identifier, wherein the storage area identifier is a prefix of the second functional identifier and wherein the second functional identifier is distinct from the first operational identifier and wherein the second functional identifier identifies operations that are allowed access to the storage area in order to remove objects from the storage area.

13. The data processing system of claim 12, wherein the processor unit executes the computer usable program code further comprising computer usable program code to determine if the second functional identifier matches the input identifier; responsive to a determination that the second functional identifier matches the input identifier, determine, for each item of data in the storage area, whether the item of data has an item identifier wherein the value of the input is a prefix of the item identifier; and responsive to a determination that the item of data has an item identifier wherein the value of the input is a prefix of the item identifier, erase the item of data from the storage area pad area and erase the item identifier of the item of data.

14. The data processing system of claim 12, wherein the processor unit executes the computer usable program code further comprising computer usable program code to responsive to a determination that the first functional identifier is not a prefix of the input identifier and that the second functional identifier does not match the input identifier, returning an error message to the requester.

15. The data processing system of claim 12, wherein the processor unit executes the computer usable program code further comprising computer usable program code to determine if the first functional identifier is a prefix of the input identifier; and responsive to a determination that the first functional identifier is a prefix of the input identifier, perform a read or write operation in the storage area for the value.
